(19) United States
(12) Patent Application Publication
(10) Pub. No.: US 2007/0222565 A1
(43) Pub. Date: Sep. 27, 2007

(54) Pedestrian detecting device for vehicle

(75) Inventors: Shiyouta Kawamata, Hiroshima (JP); Haruhisa Kore, Hiroshima (JP); Takanori Kume, Hiroshima (JP)

Correspondence Address: NIXON PEABODY, LLP, 401 9TH STREET, NW, SUITE 900, WASHINGTON, DC, 20004-2128, US

(73) Assignee: MAZDA MOTOR CORPORATION

(21) Appl. No.: 11/708,463

(22) Filed: Feb. 21, 2007

(30) Foreign Application Priority Data
Mar. 27, 2006 (JP) 2006-085435

(51) Int. Cl. B60Q 1/00; G06K 9/00; H04N 7/18

(52) U.S. Cl. 340/435; 348/148; 382/103

(57) ABSTRACT

A pedestrian detecting device for a vehicle comprises a far-infrared camera picking up a far-infrared image outside the vehicle, an area-candidate extracting portion extracting an area candidate containing a pedestrian image from the far-infrared image picked up, an environment detecting device detecting an environment outside the vehicle that influences the far-infrared image, a ROM storing a pedestrian model in the far-infrared image in association with the environment outside the vehicle, a pedestrian-model extracting portion extracting a pedestrian model associated with the environment that is detected by the environment detecting device from the ROM, and a pedestrian determining portion determining, for a pedestrian detection, whether or not the area candidate contains the pedestrian image, by comparing the area candidate extracted to the pedestrian model extracted. Accordingly, the detection accuracy of the pedestrian can be improved.

### BACKGROUND OF THE INVENTION

The present invention relates to a pedestrian detecting device for a vehicle, and more specifically, relates to a pedestrian detecting device for a vehicle that detects a pedestrian by picking up a far-infrared image.

A technology of detecting a pedestrian outside a vehicle, particularly, in front of the vehicle, for an assistance of vehicle driving or the like has been recently developed. Japanese Patent Laid-Open Publication No. 2004-266767 discloses a technology of detecting the pedestrian with a far-infrared camera, for example. Also, US Patent Application Publication No. 2005/0231339 A1 discloses a technology of detecting the pedestrian with a stereo camera and a far-infrared camera.

The detection of the pedestrian with the far-infrared camera is conducted by detecting a difference in temperature between the pedestrian and surrounding structures. Therefore, the pedestrian detection may be properly conducted at night when the temperature of surfaces of the surrounding structures is relatively low.

At daytime, however, especially under the sunshine, the temperature of the surrounding structures, roads and the like goes up and so there is little temperature difference between them and the pedestrian, in general. Accordingly, it may be difficult to detect properly the pedestrian in the daytime.

Also, clothes the pedestrian puts on generally change depending on the season and the like. Thus, a pedestrian image within a far-infrared image may change depending on the kind of clothes of the pedestrian. For example, the pedestrian image with the far-infrared rays may change when the pedestrian puts on a long-sleeve shirt or a short-sleeve shirt.

### SUMMARY OF THE INVENTION

An object of the present invention is to provide a pedestrian detecting device for a vehicle that can improve the detection accuracy of the pedestrian with the far-infrared rays even at daytime.

According to the present invention, there is provided a pedestrian detecting device for a vehicle, which is installed in, the vehicle, comprising an image pickup device to pick up a far-infrared image outside the vehicle, an environment detecting device to detect an environment outside the vehicle that influences the far-infrared image picked up by the image pickup device, a pedestrian-model storing device to store data of a pedestrian model in the far-infrared image to be picked up by the image pickup device in association with the environment outside the vehicle to be detected by the environment detecting device, an area-candidate extracting device to extract a candidate of an area that contains a pedestrian image from the far-infrared image picked up by the image pickup device, a pedestrian-model extracting device to extract a specified pedestrian model from the stored data of the pedestrian model that is stored in the pedestrian-model storing device, the specified pedestrian model associated with the environment outside the vehicle that is detected by the environment detecting device, and a pedestrian determining device to determine, for a pedestrian detection, whether or not the area candidate contains the pedestrian image, by comparing the area candidate extracted by the area-candidate extracting device to the pedestrian model extracted by the pedestrian-model extracting device.

According to the above-described pedestrian detecting device for a vehicle of the present invention, the pedestrian detection is conducted by a determination of matching of the pedestrian model that is associated with the environment outside the vehicle. Thereby, even at daytime, the detection accuracy of the pedestrian can be improved with the far-infrared rays.

According to an embodiment of the present invention, the environment detecting device detects at least one of a season, temperature, luminous intensity of sunshine, and sunshine time as the environment outside the vehicle. In general, clothes of the pedestrian or the temperature of skins of the pedestrian change depending on the environment outside the vehicle like these conditions. Thus, a detection of these environment conditions can improve the detection accuracy of the pedestrian.

According to another embodiment of the present invention, the pedestrian model of the data stored by the pedestrian-model storing device comprises plural part models that are defined by a relative position, and the determination by the pedestrian determining device is conducted based on matching of each of part models. Thereby, since the matching of each of the part models of the pedestrian is conducted, the detection accuracy of the pedestrian can be further improved.

According to another embodiment of the present invention, the pedestrian-model storing device stores data of an average intensity of far-infrared rays for each part of the pedestrian model, and the determination by the pedestrian determining device is conducted based on matching of each part model of the pedestrian with respect to the average intensity of far-infrared rays of each of part models. Thereby, since the average intensity of the far-infrared rays of each of part models is used, the above-described matching can be conducted properly and easily.

According to another embodiment of the present invention, the pedestrian-model storing device stores data of a distribution of intensity of far-infrared rays for each part of the pedestrian model, and the determination by the pedestrian determining device is conducted based on matching of each part model of the pedestrian with respect to the intensity distribution of far-infrared rays of each of part models. Thereby, since the intensity distribution of the far-infrared rays of each of part models is used, the above-described matching can be conducted properly and easily.

According to another embodiment of the present invention, the environment detecting device detects a signal transmitted by an IC tag that is put on clothes of a pedestrian as the environment outside the vehicle, the pedestrian-model storing device stores data of the pedestrian model in the far-infrared image in association with the signal of the IC tag, and the pedestrian-model extracting device extracts a specified pedestrian model associated with the signal of the IC tag detected by the environment detecting device from the stored data of the pedestrian model stored in the pedestrian-model storing device. Thereby, since the matching is conducted by using the pedestrian model in association with the signal of the IC tag putting on the clothes of the pedestrian, the detection accuracy of the pedestrian can be improved.

According to another embodiment of the present invention, there is further provided a visible-image pickup device to pick up a visible image outside the vehicle, and the pedestrian determining device conducts a pedestrian detection based on the visible image for the area candidate. Thereby, the detection accuracy of the pedestrian can be improved.

Other features, aspects, and advantages of the present invention will become apparent from the following description that refers to the accompanying drawings.

### BRIEF DESCRIPTION OF THE DRAWINGS

FIG. 1 is a block diagram showing a structure of a pedestrian detecting device according to an embodiment.

FIG. 2 is a schematic diagram showing a layout of the pedestrian detecting device according to the embodiment in a vehicle.

FIG. 3 is an example of an association between an environment outside the vehicle and a pedestrian model.

FIG. 4 is a flowchart of an operation of the pedestrian detecting device according to the embodiment.

FIG. 5A is an example of a far-infrared image, FIG. 5B is an example of an extracted high-temperature area, and FIG. 5C is an example of an extracted area candidate.

FIG. 6A is an example of the pedestrian model, and FIG. 6B is an example of each part of the area candidate.

FIG. 7 is an example of an association between an IC tag signal and a pedestrian model according to a second embodiment.

### DETAILED DESCRIPTION OF THE INVENTION

Hereinafter, preferred embodiments of a pedestrian detecting device for a vehicle (hereinafter, referred to as “present device”) of the present invention referring to the accompanying drawings.

### Embodiment 1

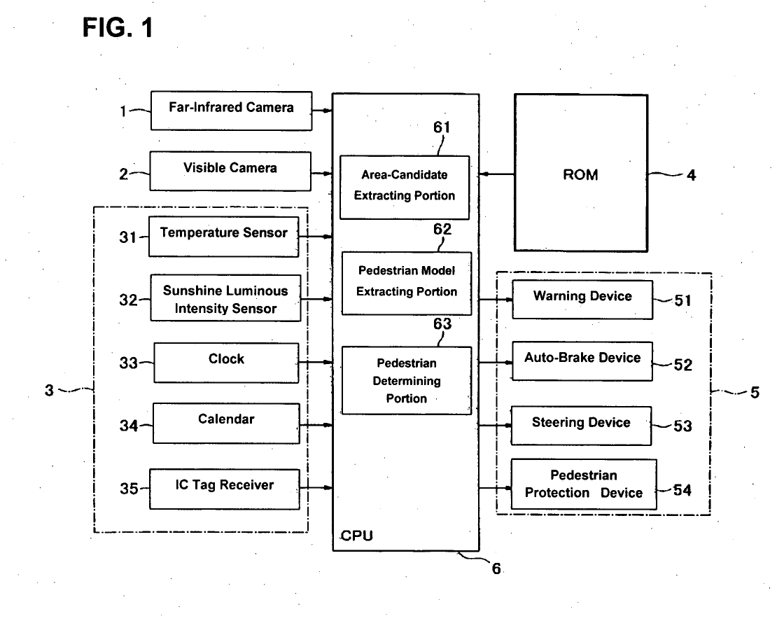

A block diagram of FIG. 1 shows a structure of the pedestrian detecting device for a vehicle according to an embodiment. The present device, as shown in FIG. 1, comprises a far-infrared camera 1 as an image pickup device to pick up a far-infrared image outside the vehicle, a visible camera 2 as a visible-image pickup device to pick up a visible image outside the vehicle, an environment detecting device 3 to detect an environment outside the vehicle that influences the far-infrared image, a ROM 4 as a pedestrian-model storing device to store data of a pedestrian model in the far-infrared image in association with the environment outside the vehicle, an output device 5, and a CPU (central processing unit) 6.

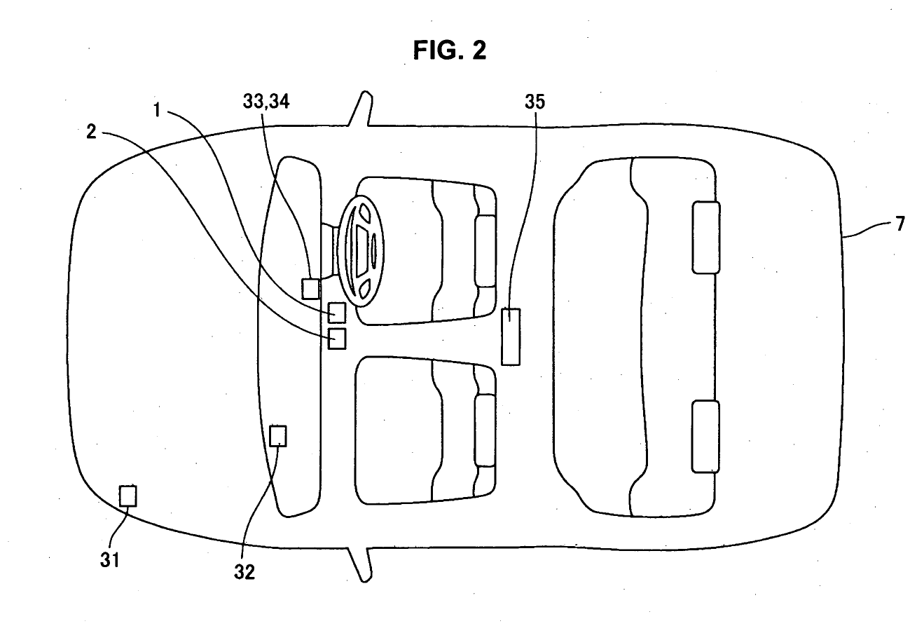

The far-infrared camera 1, visible camera 2, and environment detecting device 3 are disposed at respective proper portions in the vehicle 7 as shown in FIG. 2. The far-infrared camera 1 and visible camera 2 are located in front of the vehicle to pick up images of objects in the present embodiment. The far-infrared camera 1 is a camera operative to pick up an intensity distribution of a heat radiation of the objects within a far-infrared wavelength band of 8 to 12 μm as the picked-up image.

There are provided a calendar 34 to detect a season, a temperature sensor 31 to detect a temperature outside the vehicle, a sunshine luminous intensity sensor 32 to detect a luminous intensity of sunshine, and a clock 33 to detect the time, which are sensors as the environment detecting device 3. Further, there is provided an IC tag receiver to detect a signal transmitted by an IC tag (not illustrated) that is put on clothes of the pedestrian. The calendar 34 and clock 33 may be preferably comprised of an electronic calendar and clock installed in a car navigation system, for example. The temperature sensor 31 and sunshine luminous intensity sensor 32 may be also comprised of preferable sensors. FIG. 2 shows a layout of an antenna for receiving the IC tag signal as the IC tag receiver 25.

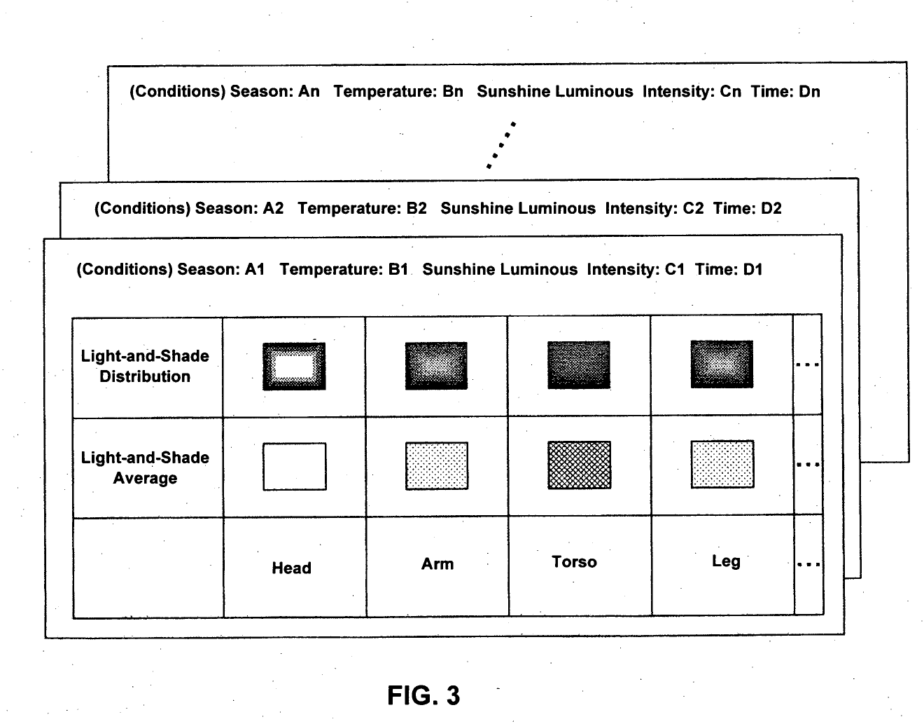

The ROM 4 as the pedestrian-model storing device, as shown in FIG. 3, stores data of an average intensity of far-infrared rays and a distribution of intensity of far-infrared rays for each part of the pedestrian model, such as a head, arm, torso, leg, in association with environment conditions outside the vehicle of the season (A1-An), temperature ((B1-Bn), sunshine luminous intensity (C1-Cn), and time (D1-Dn). In FIG. 3, a degree of the intensity of far-infrared rays is illustrated as a light and shade for convenience. Herein, a lighter area means an area having a higher intensity, while a darker (shading) area means an area having a lower density.

An average of the light and shade of each part of the pedestrian model is a magnitude that is obtained by averaging the degree of the light and shade in a whole area of each part of the pedestrian model. Also, a distribution of the light and shade shows a location change of the light and shade within each part of the pedestrian model. Herein, in general, the light and shade of the pedestrian model, i.e., the intensity of far-infrared rays with respect to the heat radiation corresponding to a surface temperature, considerably change depending on whether the pedestrian's skin is covered with the clothes or not (exposed). In the example shown in FIG. 3, the average of the light and shade of the head portion including an exposed face is relatively high (light), while the average of the light and shade of the torso portion covered with the clothes is relatively low (dark).

Further, in the example shown in FIG. 3, the distribution of the light and shade of each part of the pedestrian model is such that the light and shade at a central portion of each part of the model, i.e., at an area that straightly faces the far-infrared camera, is relatively high, while the light and shade at a peripheral portion of each part of the model, i.e., an area that does not straightly face the far-infrared camera, is relatively low.

Each part of the pedestrian model is defined by a relative position. For example, the head of the pedestrian model is defined as the part that is located above the torso of the pedestrian model, the leg is defined as the part that is located below the torso, and the arm is defined as the part that is located beside the torso.

The above-described storing of data of the pedestrian model may be configured such that a plurality of pedestrian models are associated with the environment conditions. Also, the above-described location definition of the part models may be configured such that a plurality of definitions are set for a particular pedestrian model.

Further, the data of the part models of the pedestrian model may be stored for all of the environment conditions, or some data of only fundamental models may be stored and other data for other models may be obtained by modifying the fundamental models according to respective environment conditions detected.

The output device comprises a warning device 51, auto-brake device 52, steering device 53, and pedestrian protection device 54. According to the present embodiment, a driving assist control is conduced by these devices when the pedestrian is detected and the vehicle hitting the pedestrian is predicted. The warning device 51 provides a warning sound and the auto-braking device 52 provides an urgent braking to avoid the hitting of the pedestrian, for example. Also, the steering device 53 automatically operates for an avoidance of the pedestrian hitting. When the pedestrian hitting is predicted, the pedestrian protection device 54 operates to inflate airbags on an engine hood or a windshield to reduce a damage of the pedestrian that may be caused by the hitting.

The CPU 6 conducts an area-candidate extracting processing to extract the area candidate that contains the pedestrian image from the far-infrared image picked up by the far-infrared camera 1, a pedestrian-model extracting processing to extract the pedestrian model from the stored data of the pedestrian model in the RAM 4 that is associated with the environment outside the vehicle detected by the environment detecting device 3, and a pedestrian determining processing to determine, for the pedestrian detection, whether or not the area candidate contains the pedestrian image, by comparing the area candidate extracted to the pedestrian model extracted. The above-described proceeding are shown in FIG. 1, for convenience, by three function blocks of an area-candidate extracting portion 61 (as an area-candidate extracting device), a pedestrian-model extracting portion 62 (as a pedestrian-model extracting device), and a pedestrian determining portion 63 (as a pedestrian determining device) of the CPU 6.

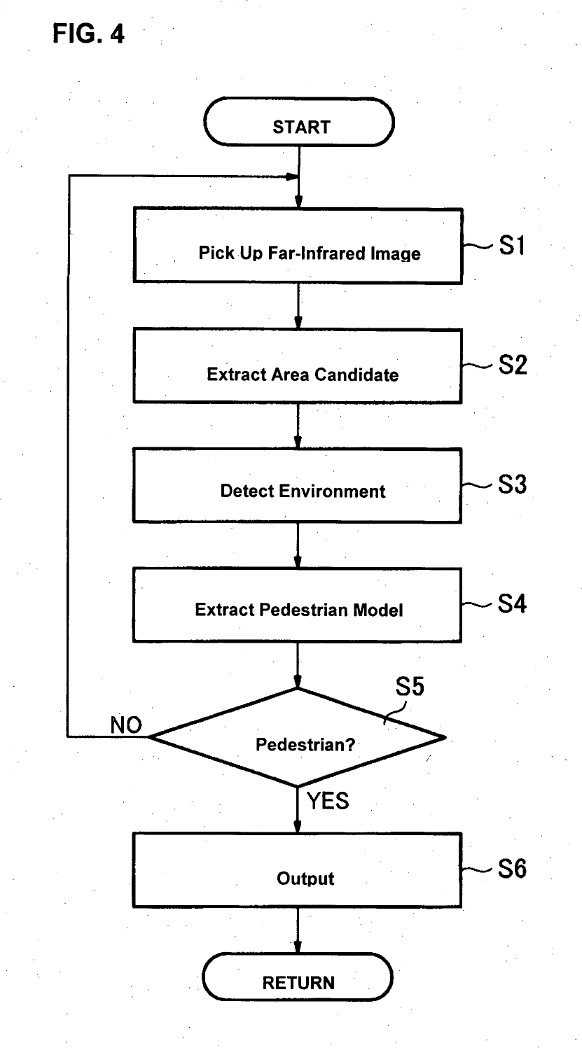

Next, the operation of the pedestrian detecting device for a vehicle according to the present embodiment will be described referring to a flowchart of FIG. 4. FIG. 4 just shows one example of control processing, and the order of a far-infrared image pickup processing (S1) and an area-candidate extracting processing (S2) with respect to an environment detecting processing (S3) and a pedestrian-model extracting processing (S4) may be changed, or these processing may be executed in parallel. Also, the far-infrared image pickup processing (S1) may be executed continuously, while the environment detecting processing (S3) may be executed periodically or under specified conditions.

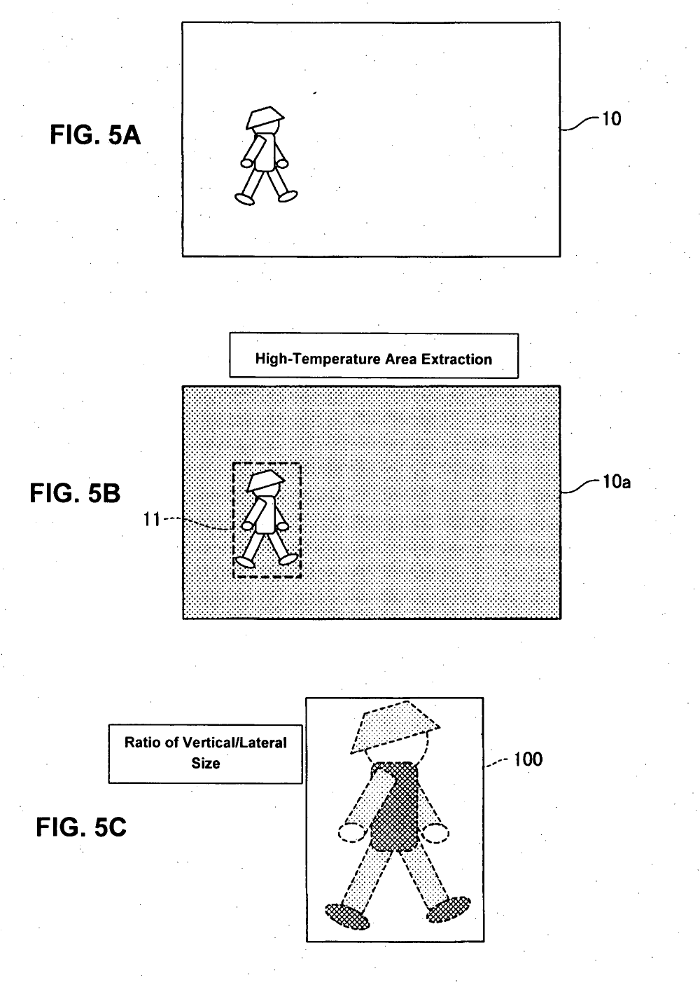

In the present embodiment -at first, a far-infrared image outside the vehicle is picked up by the far-infrared camera 1 (S1). The picked-up far-infrared image 10 is shown in FIG. 5A. In FIG. 5A, an illustration of background images other than the pedestrian's image is omitted for convenience.

Subsequently, the area candidate that may possibly contains the pedestrian image is extracted from the picked-up far-infrared image by the area-candidate extracting portion 61 of the CPU 6 (S2). Herein, firstly the far-infrared image 10 is processed as shown in FIG. 5B so that a light area (high-temperature area) 11 can be extracted. In general, other objects than pedestrians, such as, a mail post, may be also detected as an image of this light area (high-temperature area).

Therefore, according to the present embodiment, as shown in FIG. 5C, a particular area that highly possibly contain the pedestrian image is extracted by using more specific determining factors, such as a ratio of the vertical length to the lateral length of the image or a size of an extracted area. Thus, this particular area can be extracted as an area candidate 100.

Further, any environment outside the vehicle that influences the far-infrared image picked up is detected by the environment detecting device 3 (S3). In the present embodiment, specifically, the season is detected by the electric calendar 34 in the car navigation system (not illustrated), the temperature outside the vehicle is detected by the temperature sensor 31, the luminous intensity of sunshine is detected by the sunshine luminous intensity sensor 32, and the time is detected by the clock 33.

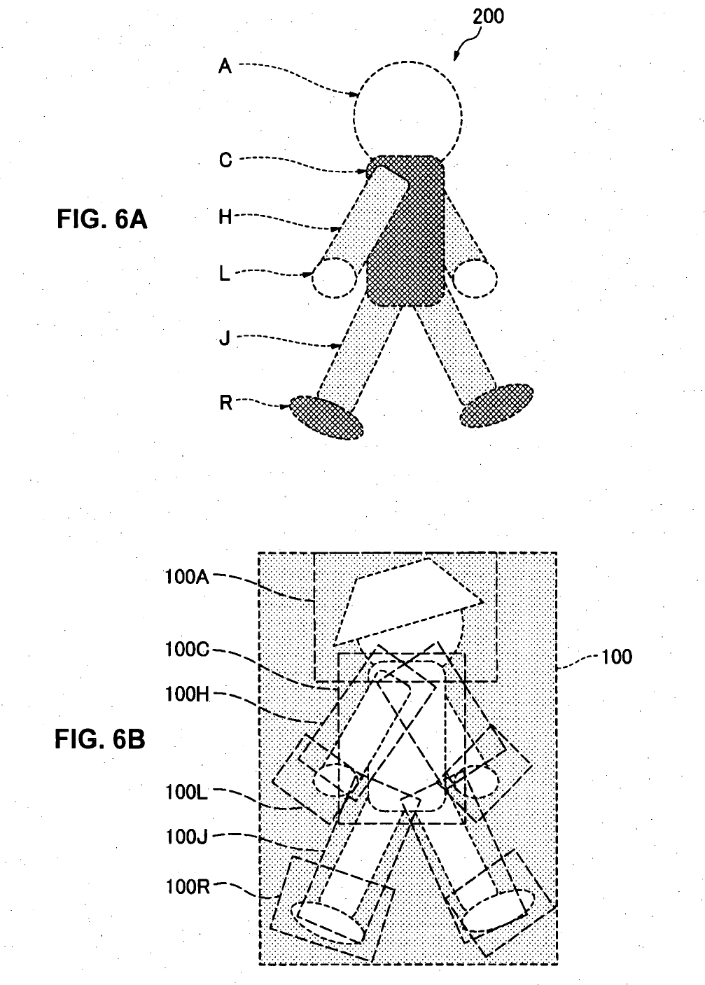

Then, a specified pedestrian model that is associated with the environment outside the vehicle detected by the environment detecting device 3 (31 to 34) is extracted from the stored data of the pedestrian model stored in the ROM 4 by the pedestrian-model extracting portion 62 of the CPU 6 (S4). Herein, the pedestrian model is comprised of plural parts of the model, and the average of the light and shade (the intensity of far-infrared rays) and the distribution of the light and shade (the intensity of far-infrared rays) that are respectively associated with the environment outside the vehicle detected, such as the season A1, temperature B1, sunshine luminous intensity C1 and time D1, are used with respect to the each part pedestrian model. A pedestrian model 200 that is comprised of a head model A, torso model C, arm model H, hand model L, leg model J and foot model R is schematically shown in FIG. 6A.

Then, a pedestrian detection is conducted by the pedestrian determining portion 63 that determines whether or not the area candidate 100 contains the pedestrian image, by comparing the area candidate 100 extracted by the area-candidate extracting portion 62 to the pedestrian model 200 extracted by the pedestrian-model extracting portion 61 (S5).

Herein, as shown in FIG. 6B, plural area candidates are defined based on a relative position in the pedestrian and each of the area candidates is further extracted from the area candidate 100. In the example of FIG. 6B, a head area candidate 100A, torso area candidate 100C, arm area candidate 100H, hand area candidate 100L, leg area candidate 100J and foot area candidate 10OR are extracted from the whole area candidate 100.

Then, the matching for each of the part models of the pedestrian model and the area candidates are conducted by the pedestrian determining portion 63. Specifically, the matching of the head model A and the head area candidate 100A, the matching of the torso model C and the torso area candidate 100C, the matching of the arm model H and the arm area candidate 100H, the matching of the hand model L and the hand area candidate 100L, the matching of the leg model J and the hand area candidate 100L, and the foot model R and the foot area candidate 100 R are conducted.

Herein, the pedestrian determining portion 63 of the CPU 6 obtains the intensity average and the intensity distribution of the far-infrared rays for each of the area candidate, and conducts a matching determination for each of the part models of the pedestrian model with respect to the intensity average and the intensity distribution of the far-infrared rays by comparing these related obtained data to these related stored data. The final determination of the pedestrian image is made based on results of these all matching.

When the pedestrian image is determined, the output device 5 is operated for the driving assistance, especially in a case where the vehicle hitting the pedestrian is predicted (S6).

### Embodiment 2

A second embodiment will be described. It has been recently proposed from products management control standpoints that an IC tag is sewed on clothes. Accordingly, a signal transmitted by the IC tag of the clothes may be used for the pedestrian detection according to the second embodiment. The signal of the IC tag contains codes to identify a material or shape of clothes, for example. Thereby, the material and the like of the clothes that the pedestrian puts on can be identified by receiving the signal of the IC tag. Since an energy or a spectrum distribution of the heat radiation from objects change depending on not only the temperature of the objects but the kinds of the objects, the identification of the material of clothes by the IC tag signal can improve the accuracy of the pedestrian detection with the far-infrared image.

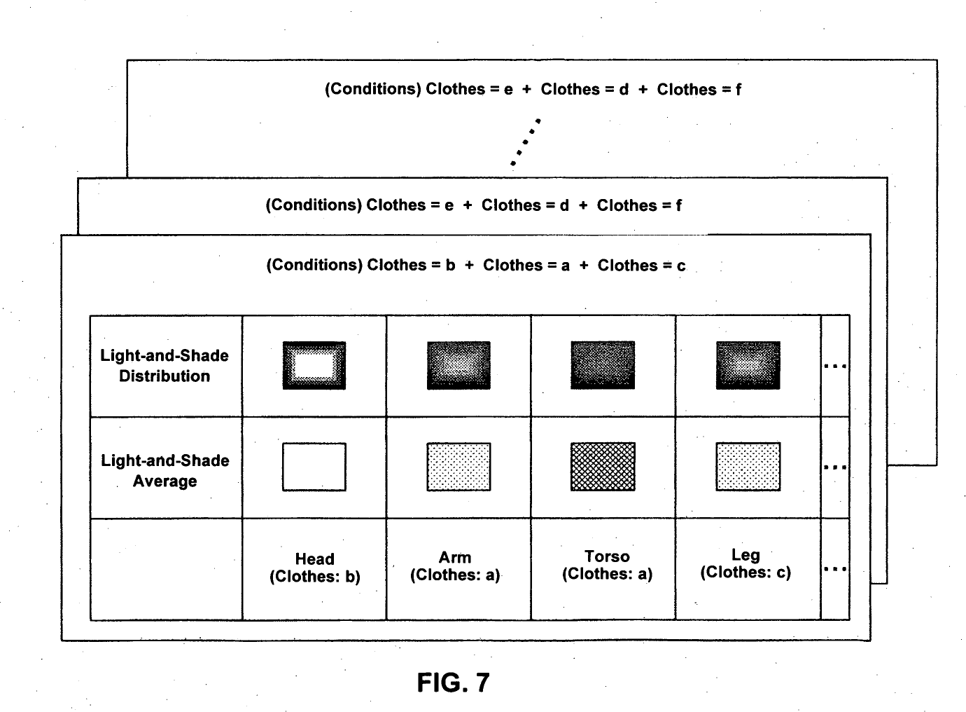

The structure of the pedestrian detecting device for a vehicle of the second embedment is substantially the same as that showed in FIG. 1, and the pedestrian detection processing is substantially the same as the flowchart of FIG. 4. According to the second embodiment, however, the ROM 4 stores the pedestrian model in the far-infrared image in association with the signal of the IC tag as shown in FIG. 7.

In the example shown in FIG. 7, data of the average intensity of far-infrared rays and the distribution of intensity of far-infrared rays for each part of the pedestrian model, such as the head, arm, torso, leg, are stored in association with clothes with the IC tag that comprises a hat b, jacket b, and pants c, for example.

An IC tag receiver 35 transmits an operational signal forward of the vehicle and receives a signal that is transmitted by the IC tag that is put on clothes of the pedestrian as the environment outside the vehicle (S3 of FIG. 4). The pedestrian-model extracting portion 62 of the CPU 6 extracts a part model putting on the clothes that is associated with the IC tag signal received is extracted from the ROM 4, and creates the pedestrian model in the far-infrared image in the same ways as the first embodiment (S4). Thereby, the pedestrian can be detected, like the first embodiment.

Herein, although the pedestrian can be detected just by using the IC tag signal, a more accurate location of the pedestrian can be detected by detecting the pedestrian from the far-infrared image. Further, combining the IC tag signal and other environment outside the vehicle, such as the season or the sunshine luminous intensity, can improve the detection accuracy of the pedestrian.

Further, by providing the visible camera 2 picking up a visible image outside the vehicle, and by making the pedestrian determining portion 63 detect the pedestrian with the visible image picked up by the visible camera 2 in addition to the far-infrared image, the detection accuracy of the pedestrian can be further improved.

The present invention should not be limited to the above-described embodiments, and any other modifications and combinations may be applied

What is claimed is:

1. A pedestrian detecting device for a vehicle, which is installed in the vehicle, comprising:
an image pickup device to pick up a far-infrared image outside the vehicle;
an environment detecting device to detect an environment outside the vehicle that influences the far-infrared image picked up by the image pickup device;
a pedestrian-model storing device to store data of a pedestrian model in the far-infrared image to be picked up by the image pickup device in association with the environment outside the vehicle to be detected by the environment detecting device;
an area-candidate extracting device to extract a candidate of an area that contains a pedestrian image from the far-infrared image picked up by the image pickup device;
a pedestrian-model extracting device to extract a specified pedestrian model from the stored data of the pedestrian model that is stored in the pedestrian-model storing device, the specified pedestrian model being associated with the environment outside the vehicle that is detected by the environment detecting device; and
a pedestrian determining device to determine, for a pedestrian detection, whether or not the area candidate contains the pedestrian image, by comparing the area candidate extracted by the area-candidate extracting device to the pedestrian model extracted by the pedestrian-model extracting device.

2. The pedestrian detecting device for a vehicle of claim 1, wherein said environment detecting device detects at least one of a season, temperature, luminous intensity of sunshine, and sunshine time as the environment outside the vehicle.

3. The pedestrian detecting device for a vehicle of claim 1, wherein the pedestrian model of the data stored by said pedestrian-model storing device comprises plural part models that are defined by a relative position, and said determination by the pedestrian determining device is conducted based on matching for each of the part models of the pedestrian model.

4. The pedestrian detecting device for a vehicle of claim 1, wherein said pedestrian-model storing device stores data of an average intensity of far-infrared rays for each part of the pedestrian model, and said determination by the pedestrian determining device is conducted based on matching of each part model of the pedestrian with respect to the average intensity of far-infrared rays of each of part models.

5. The pedestrian detecting device for a vehicle of claim 1, wherein said pedestrian-model storing device stores data of a distribution of intensity of far-infrared rays for each part of the pedestrian model, and said determination by the pedestrian determining device is conducted based on matching of each part model of the pedestrian with respect to the intensity distribution of far-infrared rays of each of part models.

6. The pedestrian detecting device for a vehicle of claim 1, wherein said environment detecting device detects a signal transmitted by an IC tag that is put on clothes of a pedestrian as the environment outside the vehicle, said pedestrian-model storing device stores data of the pedestrian model in the far-infrared image in association with the signal of the IC tag, and said pedestrian-model extracting device extracts a specified pedestrian model associated with the signal of the IC tag detected by the environment detecting device from the stored data of the pedestrian model stored in the pedestrian-model storing device.

7. The pedestrian detecting device for a vehicle of claim 1, wherein there is further provided a visible-image pickup device to pick up a visible image outside the vehicle, and said pedestrian determining device conducts a pedestrian detection based on the visible image for said area candidate.
